(19) United States
(12) Patent Application Publication
(10) Pub. No.: US 2013/0127912 A1
(43) Pub. Date: May 23, 2013

(54) ELECTRONIC DEVICE

(71) Applicant: Kang-Wen Lin, New Taipei City (TW)

(72) Inventor: Kang-Wen Lin, New Taipei City (TW)

(73) Assignee: Quanta Computer Inc., Tao Yuan Shien (TW)

(21) Appl. No.: 13/364,396

(22) Filed: Feb. 2, 2012

(30) Foreign Application Priority Data
Nov. 18, 2011 (TW) 100142406

(51) Int. Cl. G09G 5/00; G06F 3/041

(52) U.S. Cl. 345/659

(57) ABSTRACT

An electronic device including a control unit, a display panel and a sensing unit is provided. The display panel displays an electronic book. The sensing unit is electrically connected to the control unit and the display panel. When the sensing unit senses that the electronic device is rotated around a first axis over a first angle, the control unit controls the display panel to display multiple pages of the electronic book instead of a content of the electronic book. The display panel also displays multiple annotations as the display panel is annotated.

This application claims the benefit of Taiwan application Serial No. 100142406, filed Nov. 18, 2011, the subject matter of which is incorporated herein by reference.

### BACKGROUND OF THE INVENTION

1. Field of the Invention

The invention relates to an electronic device.

2. Description of the Related Art

Accompanied with technology advancement, conventional paper books are largely being replaced by digital books as a prevalent information browsing interface. In response to the trend of digital books, publishers continuously launch services of electronic books to satisfy user needs. Services of electronic books are, for example, a reader interface that displays an electronic book on a touch display provided on a mobile device such as a tablet computer. Through the interface, a user is enabled to flip pages of an electronic book via a touch input such as dragging. However, such manipulation means may still be insufficiently spontaneous to a user.

### SUMMARY OF THE INVENTION

The invention is directed to an electronic device for providing a user with optimally convenient and intuitive operations.

According to an aspect the present invention, an electronic device including a control unit, a display panel and a sensing unit is provided. The display panel displays an electronic book. The sensing unit is electrically connected to the control unit and the display panel. When the sensing unit senses that the electrical device is rotated around a first axis over a first angle, the control unit controls the display panel to display multiple pages of the electronic book instead of a content of the electronic book. The display panel further displays multiple annotations as the display panel is annotated.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is a block diagram of an electronic device according to an embodiment of the present invention.

FIG. 2 is a schematic diagram of an electronic device according to an embodiment of the present invention.

FIG. 3 is a schematic diagram of operations of an electronic device according to a first embodiment of the present invention.

FIG. 4 is a schematic diagram of operations of an electronic device according to a second embodiment of the present invention.

FIG. 5 is a schematic diagram of operations of an electronic device according to a third embodiment of the present invention.

FIG. 6 is a schematic diagram of operations of an electronic device according to a fourth embodiment of the present invention.

FIG. 7 is a schematic diagram of operations of an electronic device according to a fifth embodiment of the present invention.

FIG. 8 is a schematic diagram of operations of an electronic device according to a sixth embodiment of the present invention.

FIG. 9 is a schematic diagram of operations of an electronic device according to a seventh embodiment of the present invention.

### DETAILED DESCRIPTION OF THE INVENTION

An electronic device disclosed by the present invention is capable of providing a user with optimally intuitive operations.

FIG. 1 shows a block diagram of an electronic device according to an embodiment of the present invention. An electronic device 100, e.g., a portable reading device or a tablet computer, includes a control unit 110, a display panel 120 and a sensing unit 130. For example, the display panel 120 is a touch panel that displays an electronic book; the sensing unit 130 is a sensor, such as a tilt sensor, a stress sensor, a G sensor or an accelerator, depending on actual requirements. The sensing unit 130 is electrically connected to the control unit 110 and the display panel 120.

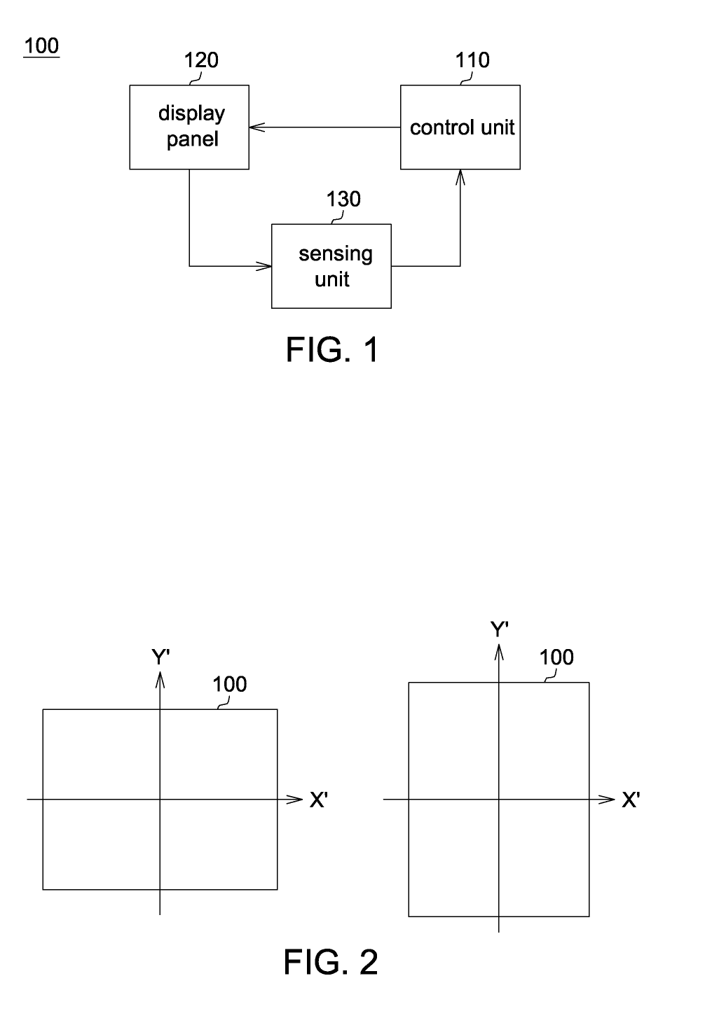

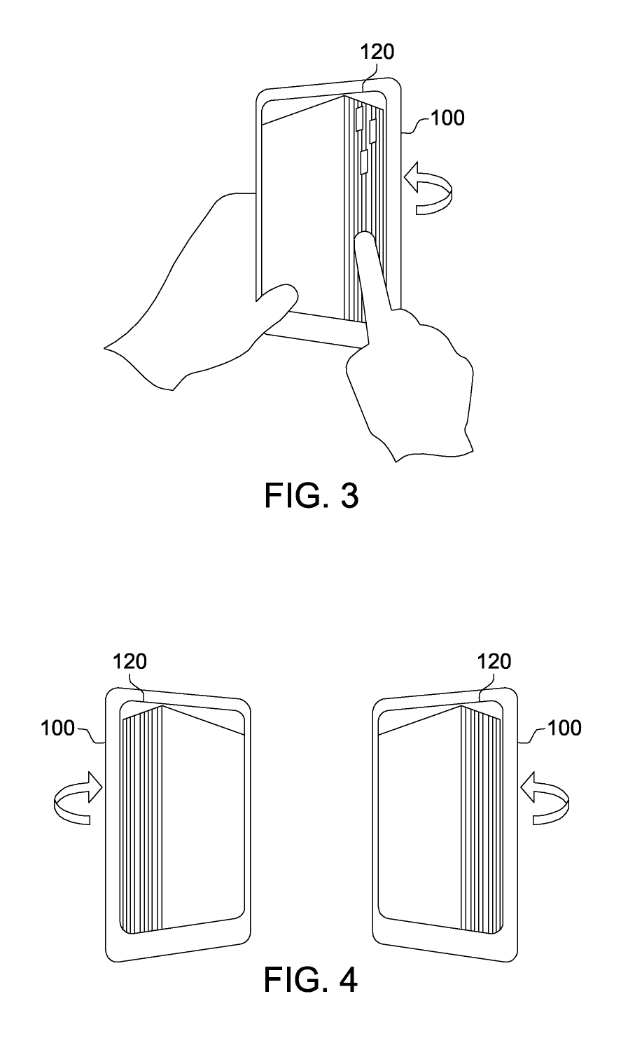

According to a held position, a first axis Y′ and a second axis X′ are defined relative to the electronic device 100, as shown in FIG. 2. The first axis Y′ is a vertical axis and the second axis X′ is a horizontal axis. FIG. 3 shows a schematic diagram of operations of an electronic device according to a first embodiment of the present invention. When the sensing unit 130 senses that the electronic device 100 is held and rotated around the first axis Y′ over a first angle α₁, the control unit 110 controls the display panel 120 to display multiple pages of the electronic book instead of a content of the electronic book. Meanwhile, the display panel 120 also displays corresponding annotations as some pages of the electronic book are annotated by a user.

FIG. 4 shows a schematic diagram of operations of an electronic device according to a second embodiment of the present invention. When the electronic device 100 is rotated towards one side (e.g., clockwise) of the first axis Y′ over the first angle α₁, the display panel 120 displays multiple pages of the electronic book that are already read. When the electronic device 100 is rotated towards the other side (e.g., counterclockwise) of the first axis Y′ over the first angle α₁, the display panel 120 displays multiple pages of the electronic book that are not yet read.

Further, when the electronic device 100 is rotated over the first angle α₁, according to a track between two objects relative to the display panel 12 as sensed by the sensing unit 130, the control unit 110 controls the display panel 120 to switch among different content hierarchies of the electronic book. For example, when a distance between two user fingers gets shorter, the display panel 120 displays a paragraph of the electronic book instead of a page of the electronic book; when a distance between two user fingers gets larger, the display panel 120 displays a chapter of the electronic instead of a page of the electronic book.

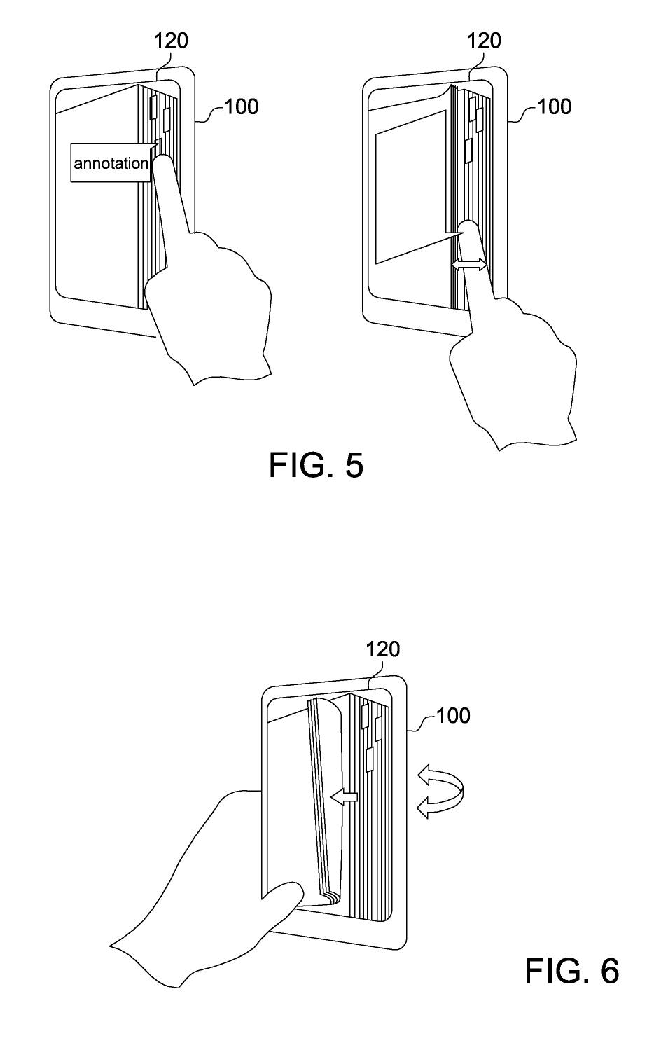

FIG. 5 shows a schematic diagram of operations of an electronic device according to a third embodiment of the present invention. When the sensing unit 130 senses that one of multiple pages displayed by the display panel 120 is touched, the control unit 110 controls the display panel 120 to display a preview of the touched page. When the sensing unit 130 senses that one of multiple annotations is touched, the control unit 110 controls the display panel 120 to display a preview of the touched annotation. Further, when the sensing unit 130 senses one of the multiple pages is touched by an object (e.g., a user finger) sliding on the display panel 120, the control unit 110 controls the display panel 120 to switch to the touched page and correspondingly display a content of the touched page.

FIG. 6 shows a schematic diagram of operations of an electronic device according to a fourth embodiment of the present invention. When the sensing unit 130 senses the electronic device 100 is rotated around the first axis Y′ by an angular acceleration over a predetermined period, the control unit 110 controls the display panel 120 to flip and display the pages at a corresponding velocity. That is, the display panel 120 flips and displays the pages at a greater velocity as a rotational speed of the electronic device 100 gets faster, and at a smaller velocity as a rotational speed of the electronic device 100 gets slower.

When the pages are being flipped and displayed, the control unit 110 controls the display panel 120 to stop flipping the pages in the event that the display panel 120 is touched. When the display panel 120 is no longer touched, the control unit 110 controls the display panel 120 to continue to flip the pages. Further, when the pages with the annotations are being flipped, the control unit 110 reduces the velocity of the page flipping to remind a user of additional information stored in the pages being flipped. For example, the additional information is an external message such as social information. Moreover, when the pages with the additional information are read or touched, the control unit 110 controls the electronic device 100 to generate a feedback status (e.g., a vibration or a voice prompt) as a reminder to the user.

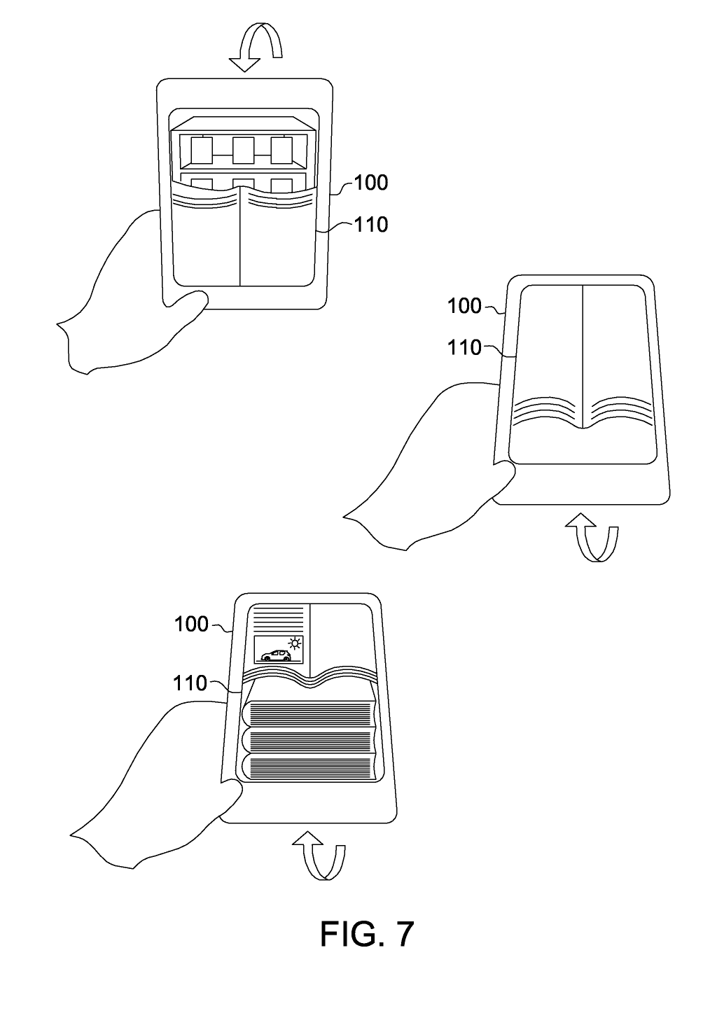

FIG. 7 shows a schematic diagram of operations of an electronic device according to a fifth embodiment of the present invention. When the sensing unit 130 senses the electronic device 100 is rotated around the second axis X′, the control unit 110 controls the display panel 120 to further display an external message or an application program. For example, when the electronic device 100 is rotated counterclockwise around the second axis X′, the display panel 120 further displays an electronic bookshelf, with books on the bookshelf being related to the electronic book being read. When the electronic device 100 is rotated clockwise around the second axis X′, the display panel 120 further displays other electronic books related to the electronic book being read. When a user touches a desired book from the related books, the display panel display panel 120 further switches to display the desired book related to the book being read.

When the electronic device 100 rotates clockwise around the second axis X′, the electronic device 100 may connect to a remote server via a network, and obtain a message left at an associated social network from the remote server. The message may then be displayed by the display panel 120, and may be a message left at associated social network corresponding to the page currently being displayed. Further, when the electronic device 100 is rotated clockwise by the second axis X′, the display panel 120 may display other application programs.

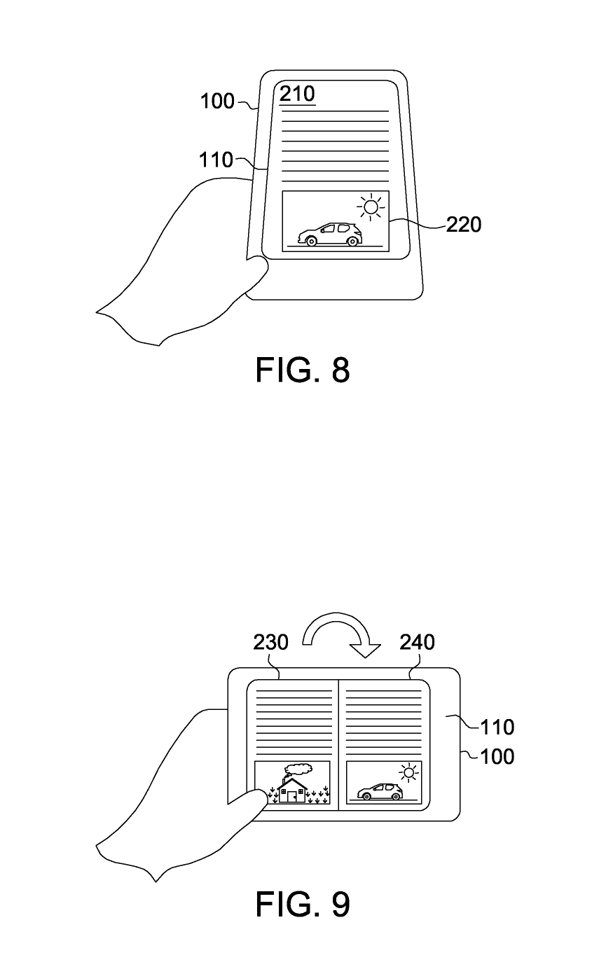

FIG. 8 shows a schematic diagram of operations of an electronic device according to a sixth embodiment of the present invention. When the electronic device 100 is rotated around the second axis X′ and an external message or application program displayed by the display panel 120 is touched, the control unit 110 controls the display panel 120 to display a content at a first region and to display associated content of the external message or application program at a second region 220 within the first region 210.

FIG. 9 shows a schematic diagram of operations of an electronic device according to a seventh embodiment of the present invention. In continuation of the operations in FIG. 8, when the electronic device 100 displays a landscape view from a portrait view, the control unit 110 controls the display panel 120 to display a content at a third region 230 and the external message or application program at a fourth region 240. The third region 230 and the fourth region 240 are non-overlapped.

Further, when the sensing unit 130 senses a first action combination (which is regarded as a lock password), the control unit 110 locks region of the electronic book as designated. When the sensing unit 130 senses a second action combination (which is regarded as an unlock password), the control unit 110 unlocks the locked region. Accordingly, through a series of actions for locking/unlocking operations, messages or annotations included in a particular region may be selectively disclosed at a social network.

Therefore, it is illustrated with the above embodiments that the electronic device and method disclosed by the present invention allow a user to operate the electronic device with more convenient and intuitive approaches through a simple sensing unit based on user kinematics, thereby offering the user with more realistic reading experiences when reading an electronic book.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An electronic device, comprising:
a control unit;
a display panel, for displaying an electronic book; and
a sensing unit, electrically connected to the control unit and the display panel;
wherein, when the sensing unit senses the electronic device is rotated around a first axis over a first angle, the control unit controls the display panel to display a plurality of pages instead of a content of the electronic book; when the electronic book is annotated, the display panel displays a plurality of annotations.

2. The electronic device according to claim 1, wherein the display panel displays the pages of the electronic book that are read when the electronic device is rotated around the first axis towards one side over the first angle, and displays the pages of the electronic book that are unread when the electronic device is rotated around the first axis towards an other side over the first angle.

3. The electronic device according to claim 1, wherein when the electronic device is rotated over the first angle, the control unit controls the display panel to switch to a different content hierarchy of the electronic book according to a track between two objects relative to the display panel as sensed by the sensing unit.

4. The electronic device according to claim 1, wherein the display panel displays a preview of the touched page when the sensing unit senses one of the pages is touched, and displays a preview of the touched annotation when the sensing unit senses one of the annotations is touched.

5. The electronic device according to claim 1, wherein when the sensing unit senses one of the pages is touched by an object sliding on the display panel, the display panel displays a content of the touched page.

6. The electronic device according to claim 1, wherein when the sensing unit senses the electronic device is rotated around the first axis by an angular acceleration over a predetermined period, the display panel flips and displays the pages at a corresponding velocity.

7. The electronic device according to claim 6, wherein the display panel stops flipping the pages when the pages are being flipped and displayed at the velocity and the display panel is touched by an object, and continues to flip the pages when the object that touched the display panel is disengaged from the display panel.

8. The electronic device according to claim 6, wherein the velocity reduces when the pages with the annotations are being flipped.

9. The electronic device according to claim 1, wherein when the sensing unit senses the electronic device is rotated around a second axis, the control unit controls the display panel to display an external message or an application program.

10. The electronic device according to claim 9, wherein when the electronic device is rotated around the second axis and the external message or the application program displayed by the display panel is touched, the control unit controls the display panel to display the content at a first region and to display the external message or the application program at a second region within the first region.

11. The electronic device according to claim 10, wherein when the electronic device is switched from a portrait view to a landscape view, the control unit controls the display panel to display the content at a third region and the external message or the application program at a fourth region, and the third and fourth regions are non-overlapping.

12. The electronic device according to claim 1, wherein when the page with the annotation or an external message is read or touched, the control unit controls the electronic device to generate a feedback status.

13. The electronic device according to claim 1, wherein the control unit locks a region of the electronic book as designated when the sensing unit senses a first action combination, and unlocks the locked region when the sensing unit senses a second action combination.
